(19) United States
(12) Patent Application Publication
(10) Pub. No.: US 2026/0307425 A1
(43) Pub. Date: Oct. 8, 2026

(54) SECURITY FEATURES FOR IDENTIFICATION DOCUMENTS AND METHODS OF MAKING SAME

(71) Applicant: IDEMIA IDENTITY & SECURITY USA LLC, Reston, VA (US)

(72) Inventors: Ashley S.R. Tiguy, Billerica, MA (US); Joseph Picardi, Lexington, MA (US); Robert L. Jones, Andover, MA (US)

(21) Appl. No.: 19/172,309

(22) Filed: Apr. 7, 2025

(51) Int. Cl. B42D 25/435; B32B 3/30; B32B 7/12; B32B 27/08; B42D 25/23; B42D 25/45

(52) U.S. Cl. CPC B42D 25/435; B32B 3/30; B32B 7/12; B32B 27/08; B42D 25/23; B42D 25/45; B32B 2307/412; B32B 2307/42; B32B 2425/00

(57) ABSTRACT

A security document is provided that includes a core layer including a first set of information printed thereon and a second set of information ablated into the core with a laser to form one or more trenches. The ablated second set of information overlies and removes a portion of the first set of information. The document also includes a laminate layer including an inner surface adhered to the ablated core and having an outer surface.

### FIELD

The field of the invention relates generally to security features for documents and more specifically to documents including security features and methods of making the same.

### BACKGROUND OF THE INVENTION

Documents with security features, for example identification documents (ID documents), are used to prove a multitude of aspects of an individual. One specific example of an ID document is an ID card. ID cards are used to provide identity, verify age, access secure areas, evidence driving privileges, and they have many other uses.

Many types of ID documents in general and ID cards more specifically, such as driving licenses, national or governmental identification cards, bank cards, credit cards, controlled access cards and smart cards carry thereon certain items of information which relate to the identity of the bearer. Examples of such information include name, address, birth date, signature and photographic image. In addition, the cards may carry other variant data (i.e., data specific to a particular card or document, for example an employee number) and invariant data (i.e., data common to a large number of cards, for example the name of an employer). The cards described above and cards of a similar nature will hereinafter be generically referred to as “ID documents”.

ID documents typically include a preprinted core, also referred to as a substrate. In some applications the core can be a light colored, opaque material, such as, for example, polyvinyl chloride (PVC). The core is typically laminated with a transparent material, such as clear PVC material. The composite of the core and the clear laminate form a so-called “card blank”. Information is printed on the core. The information may include, for example, an indicium or indicia such as the invariant or nonvarying information common to a large number of identification documents, for example the name and logo of the organization issuing the documents. The information may be formed by any known process capable of forming the indicium on the specific core material used, such as laser etching or engraving.

Laser beams can be used to mark, write, bar code, ablate, etch and engrave many different types of materials. Lasers have been used, for example, to mark plastic materials to create indicia such as bar codes, date codes, part numbers, batch codes and company logos. It will be appreciated that laser ablation, laser engraving or marking generally involves a process of inscribing, ablating or engraving a document surface with identification marks, characters, text, tactile marks, including text, patterns designs (e.g., decorative or security features, photographs), etc.

Counterfeiters are always improving their tactics to simulate credential security features and accordingly, work is constantly required to improve existing features or develop new features.

### BRIEF DESCRIPTION OF THE INVENTION

A security document is provided that includes a core layer including a first set of information printed onto the core and a second set of information ablated from the core with a laser to form one or more trenches. The ablated second set of information overlies and removes a portion of the first set of information. The document also includes a laminate layer including an inner surface adhered to the ablated core and having an outer surface.

A method of manufacturing an ID document includes printing a first set of information onto a card core and ablating a second set of information into the core with a laser to form one or more trenches. The ablated second set of information overlies and removes a portion of the first set of information. The method also includes adhering a laminate layer to the core to cover the ablated second set of information.

### BRIEF DESCRIPTION OF THE DRAWINGS

FIG. 1 is an illustrative example of a portion of a security document as it would appear when viewed under ambient room lighting.

FIG. 2A is an illustrative example of the portion of the security document shown in FIG. 1 as it would appear when viewed with a white light shining directly on the front of the security document.

FIG. 2B is an illustrative example of the portion of the security document shown in FIG. 1 as it would appear when viewed with a white light that is shining on the front of the security document at an angle.

FIG. 3A is an illustrative example of the portion of the security document shown in FIG. 1 as it would appear when viewed from the front with a white light shining directly on the back of the security document.

FIG. 3B is an illustrative example of a back of the portion of the security document shown in FIG. 1 as it would appear when viewed with white light that is shining directly on the back of the security document.

FIG. 3C is another illustrative example of the portion of the security document shown in FIG. 1 as it would appear when viewed with white light that is shining directly on the back of the security document.

FIG. 4 is an illustrative example of the portion of the security document shown in FIG. 1 as it would appear when viewed with an IR or UV light shining directly on the front of the security document.

FIGS. 5A-5E are illustrative cross sections of a security document that is laser ablated and then laminated.

FIG. 6 is a flow chart illustrating the process of creating a security document such as the one shown in FIG. 1 that utilizes a static data implementation.

FIG. 7 illustrates an alternative process of manufacturing a security document such as the one shown in FIG. 1 that utilizes a variable data implementation.

### DETAILED DESCRIPTION OF THE INVENTION

The methods and systems described herein provide an enhanced security document that combines a number of security features in a single document. In one embodiment, the security document includes a multitude of preprinted features and laser ablated information and patterns to create a security feature that is both optically variable and tactile to the touch. The security features on the security document are created by printing an offset pre-printed pattern on the core, then ablating a second pattern into the core and into the offset printed pattern with a CO₂ laser that trenches out core material in the ablated pattern and removes some of the offset pre-printed pattern. This interlacing/interaction of patterns improves the level of security of the document and makes it more difficult to tamper. This ablated pattern is able to be seen within the offset printed pattern. Once the core is laminated, the ablated pattern is seen on the surface of the card since lamination takes on the contours of the ablated core surface to create depressions therein that may create a tactile to the touch characteristic depending upon the depth of the trenches. In addition, the lamination will exhibit a higher gloss in the depressions than those areas of the laminate outer surface that are not depressed. In one embodiment, at least some of the laminate layer outer surface depressions that are aligned with the ablated second set of information produce a tactile characteristic on the outer surface of the laminate layer.

In the foregoing discussion, the use of the word “ID document” is broadly defined and intended to include all types of security documents and all types of ID documents, including (but not limited to), documents, magnetic disks, credit cards, bank cards, phone cards, stored value cards, prepaid cards, smart cards (e.g., cards that include one more semiconductor chips, such as memory devices, microprocessors, and microcontrollers), contact cards, contactless cards, proximity cards (e.g., radio frequency (RFID) cards), passports, driver's licenses, network access cards, employee badges, debit cards, security cards, visas, immigration documentation, national ID cards, citizenship cards, social security cards and badges, certificates, identification cards or documents, voter registration and/or identification cards, police ID cards, border crossing cards, security clearance badges and cards, gun permits, badges, gift certificates or cards, membership cards or badges, tags, CD's, consumer products, knobs, keyboards, electronic components, etc., or any other suitable items or articles that may record information, images, and/or other data, which may be associated with a function and/or an object or other entity to be identified.

Note that, for the purposes of this disclosure, the terms “document,” “card,” “badge” and “documentation” are used interchangeably.

In addition, in the foregoing discussion, “identification” includes (but is not limited to) information, decoration, and any other purpose for which an indicia can be placed upon an article in the article's raw, partially prepared, or final state. Also, instead of ID documents, the present techniques can be employed with product tags, product packaging, etc., particularly those items including an engraved and laminated structure. The term ID document thus is broadly defined herein to include these tags and packaging, etc.

“Personalization”, “Personalized data” and “Variable data” are used interchangeably herein, and refer at least to data, images, and information that are printed at the time of card personalization. Personalized data, in one embodiment, for example, is data that is “personal to” or “specific to” a specific cardholder or group of cardholders. Personalized data can include data that is unique to a specific cardholder (such as biometric information, image information), but is not limited to unique data. Personalized data can include some data, such as birthdate, height, weight, eye color, address, etc., that are personal to a specific cardholder but not necessarily unique to that cardholder (i.e., other cardholders might share the same personal data, such as birthdate). Depending on the application, however, personalized data can also include some types of data that are not different from card to card, but that are still provided at the time of card personalization. For example, a state seal that is laser engraved onto an identification document, where the laser engraving occurs during the personalization of the card, could in some instances be considered to be “personalized” information.

The terms “laser engraving” and “laser etching” are used interchangeably herein, denoting YAG laser engraving (burning). The terms “laser ablation” and “CO₂ laser ablation” are used interchangeably herein, denoting CO₂ laser ablation (removal).

The terms “indicium” and “indicia” as used herein cover not only markings suitable for human reading, but also markings intended for machine reading. Especially when intended for machine reading, such an indicium need not be visible to the human eye, but may be in the form of a marking visible only under infra-red, ultra-violet or other non-visible radiation. Thus, in at least some embodiments, an indicium formed on any layer in an identification document (e.g., the core layer) may be partially or wholly in the form of a marking visible only under non-visible radiation. Markings comprising, for example, a visible “dummy” image superposed over a non-visible “real” image intended to be machine read may also be used. Additionally, in some embodiments, an indicium may be formed by material removal as opposed to marking the substrate.

“Laminate” and “overlaminate” include (but are not limited to) film and sheet products. Laminates usable with at least some embodiments include those which contain substantially transparent polymers and/or substantially transparent adhesives, or which have substantially transparent polymers and/or substantially transparent adhesives as a part of their structure, e.g., as an extruded feature. Examples of usable laminates include at least polyester, polycarbonate, polystyrene, cellulose ester, polyolefin, polysulfone, or polyamide. Laminates can be made using either an amorphous or biaxially oriented polymer as well. The laminate can comprise a plurality of separate laminate layers, for example a boundary layer and/or a film layer.

The degree of transparency of the laminate can, for example, be dictated by the information contained within the identification document, the particular colors and/or security features used, etc. The thickness of the laminate layers is not critical, although in some embodiments it may be preferred that the thickness of a laminate layer be about 1-20 mils. Lamination of any laminate layer(s) to any other layer of material (e.g., a core layer) can be accomplished using any conventional lamination process, and such processes are well-known to those skilled in the production of articles such as identification documents. Of course, the types and structures of the laminates described herein are provided only by way of example. Those skilled in the art will appreciate that many different types of laminates are usable.

For example, in ID documents, a laminate can provide a protective covering for the printed and laser etched substrates and can provide a level of protection against unauthorized tampering (e.g., a laminate would have to be removed to alter the printed and etched information and then subsequently replaced after the alteration).

The material(s) from which a laminate is made may be transparent, but need not be. Laminates can include synthetic resin-impregnated or coated base materials composed of successive layers of material, bonded together via heat, pressure, and/or adhesive. Laminates also include security laminates, such as a transparent laminate material with proprietary security features and processes, which protects documents of value from counterfeiting, data alteration, photo substitution, duplication (including color photocopying), and simulation by use of materials and technologies that are commonly available. Laminates can also include thermosetting materials, such as epoxy.

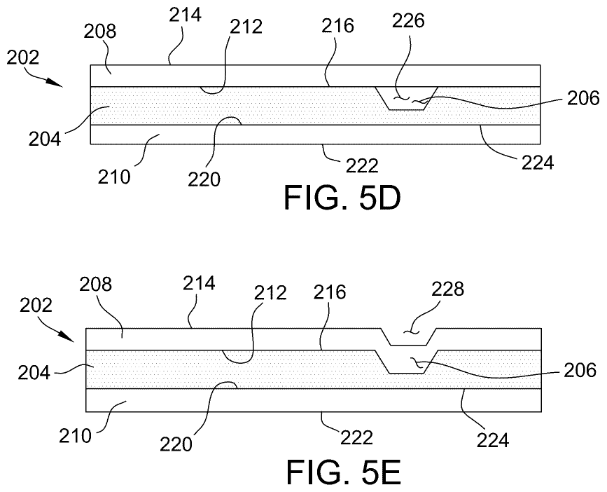

For purposes of illustration, the following description will proceed with reference to ID document structures (e.g., TESLIN-core, multi-layered ID documents) and fused polycarbonate structures. It should be appreciated, however, that the present method is not so limited. Indeed, as those skilled in the art will appreciate, the techniques detailed herein can be applied to many other structures formed in many different ways to improve their laser ablating characteristics. Generally, CO₂ laser ablation has applicability for virtually any product which is to be laser etched, engraved or ablated, especially articles to which a laminate and/or coating is applied. Exemplary core substrates, such as card core 204 shown in FIGS. 5A-5E, may be formed from paper, wood, cardboard, paperboard, glass, metal, plastic, fabric, ceramic, rubber, along with many man-made materials, such as microporous materials, single phase materials, two phase materials, coated paper, synthetic paper (e.g., TYVEC, manufactured by Dupont Corp of Wilmington, Delaware), foamed polypropylene film (including calcium carbonate foamed polypropylene film), plastic, polyolefin, polyester, polyethylenetelphthalate (PET), PET-G, PET-F, and polyvinyl chloride (PVC), and combinations thereof. An advantage of using a CO₂ laser is that it can be used in personalization centers to create personalized and unique patterns which can be useful for later comparison with a reference pattern.

In addition, at least one embodiment relates to virtually any article formed from, laminated with, or at least partially covered by a material that is not sufficiently responsive to laser radiation to form a desired indicium (e.g., a grayscale image) thereon, but which is rendered more responsive to CO₂ laser radiation, at least to a sufficient degree to enable its surface to be marked as desired with a CO₂ laser beam, by adding the CO₂ laser enhancing additive to the material itself or to another material (e.g., a coating or laminate) that is substantially adjacent to the material.

It is often desirable to mark a portion of a structure, such as a multi-layered ID document, with text, information, graphics, logos, security indicia, security features, marks, images and/or photographs. One goal of producing a secure ID document or card is to be able to manufacture it with materials and/or processes that are not readily available and to endow the card with unique, personalized features that are not easily reproduced by conventional means.

In at least some embodiments, laser ablating helps to provide unique personalized features, in that the finished ID document can be uniquely altered and personalized at the same time. In at least one embodiment, the effect produced by laser ablating can be identified easily by a person checking the card, often without special equipment, because the laser ablating produces a visual effect and/or a tactile effect. In at least one embodiment, laser ablating can produce a security feature having an optically variable (OV) quality. Laser ablating can be produced so that it cannot be easily seen when viewed straight on; a property that has the added benefit of not allowing it to be photocopied. The laser ablated feature, however, becomes very apparent in reflected light or backlight because the laser ablating creates reflecting surfaces that are not parallel to the surface of the document (e.g., the core surface and/or laminate surface). In addition, the laser removes material from the surface of the card core and may (optionally) create a pattern that can be felt by touch. This tactile property may be used to further verify the authenticity of the card.

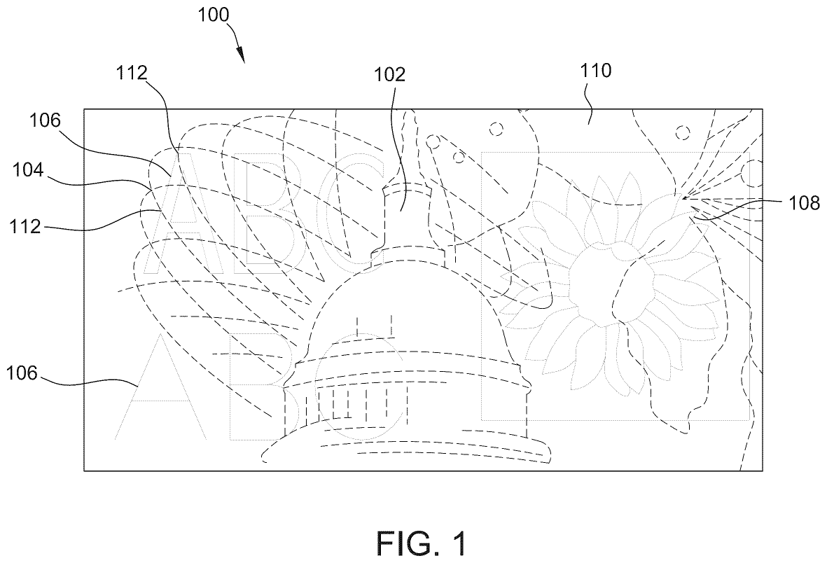

With regard to FIGS. 1-4, it is to be understood that darker lines, images and patterns do not necessarily denote darker printing. Rather, it is intended to denote elements that are more visible than other, lighter elements. Additionally, dashed lines indicate features that are printed on the card substrate and grey solid lines denote features that have been ablated.

FIG. 1 illustrates a portion of a security document 100 viewed from above with ambient room lighting that combines several security features into a single security document including a first preprinted feature 102. In this embodiment, feature 102 is a portion of a building that is offset pre-printed with ink. There is also a second offset pre-printed feature 104 printed with ink on a different background portion of security document 100. In this embodiment, feature 104 is a series of intertwined guilloche curved lines. Additionally, the laser ablated information is represented by two sets of information features 106 that are the capital letters ABC, and an additional information feature 108 that has the appearance of a flower in a box. In one embodiment, the offset pre-printed patterns and information feature 108 include at least some invariant data, and the laser ablated information feature 106 includes at least some personalized data.

Both features 106 and feature 108 have been laser ablated into a core 110 of security document 100 to form trenches and overlay portions of preprinted features 102 and 104. As illustrated in FIG. 1, laser ablated features 106 and 108 have removed the pre-printed ink from portions 112 of features 102 and 104. In one embodiment, the removal of ink from preprinted portions of feature 104 can be less visible than the removal of ink from preprinted portions of feature 102 depending on the darkness and visibility of the ink used in those areas. Also, it is to be noted that in embodiments that include thicker preprinted ink and/or deeper trenched portions, the portions of removed pre-printed ink from features 102 and 104 is more pronounced. Additionally, since the elements are laser ablated into card core 110, when the card is tilted, the observer can view varying degrees of optically variable effects with regard to patterns and/or data.

Security document 100 may be manufactured in any desired size. For example, identification documents can range in size from standard business card size (47.6 mm by 85.7 mm) up to identification booklet documents (127 mm by 177.8 mm), and can have thicknesses in the range from about 0.3 mm to about 1.3 mm.

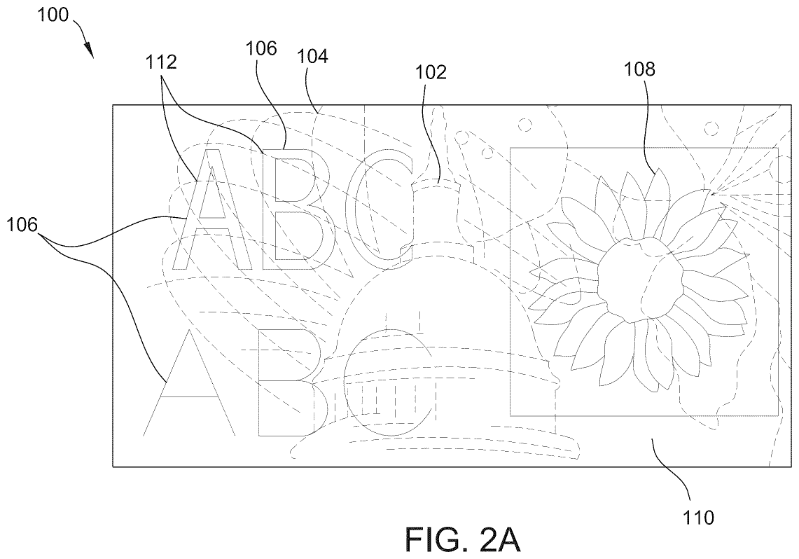

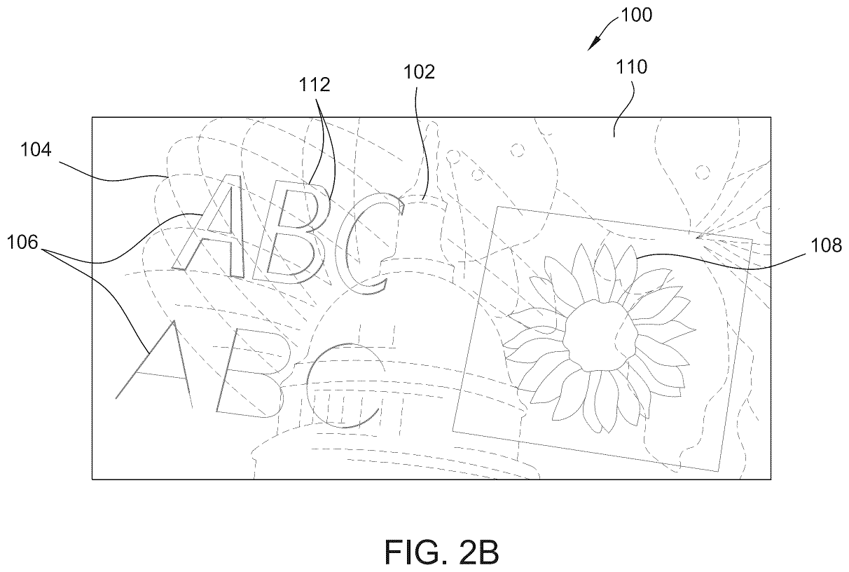

FIG. 2A illustrates the portion of security document 100 shown in FIG. 1 under a front white light shining directly on security document 100, i.e., not at an angle. FIG. 2B illustrates the portion of security document 100 shown in FIG. 1 under a front white light that is shining on security document 100 at an angle. The laser ablating of features 106 and 108 are more evident in FIGS. 2A and 2B under the front white light since it is easier to see portions 112 of removed ink from features 102 and 104. The light, both straight on and angled, create shadows in some areas of ablated features 106 and 108.

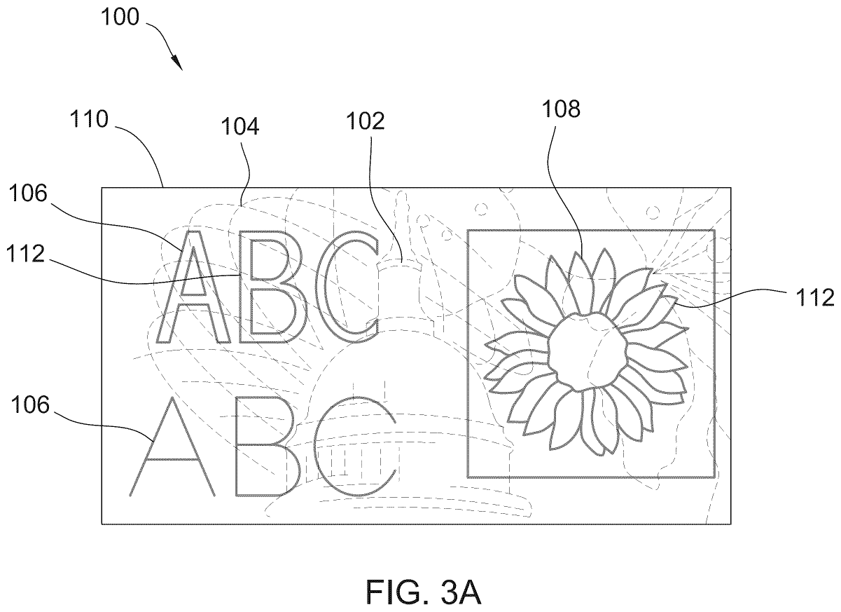

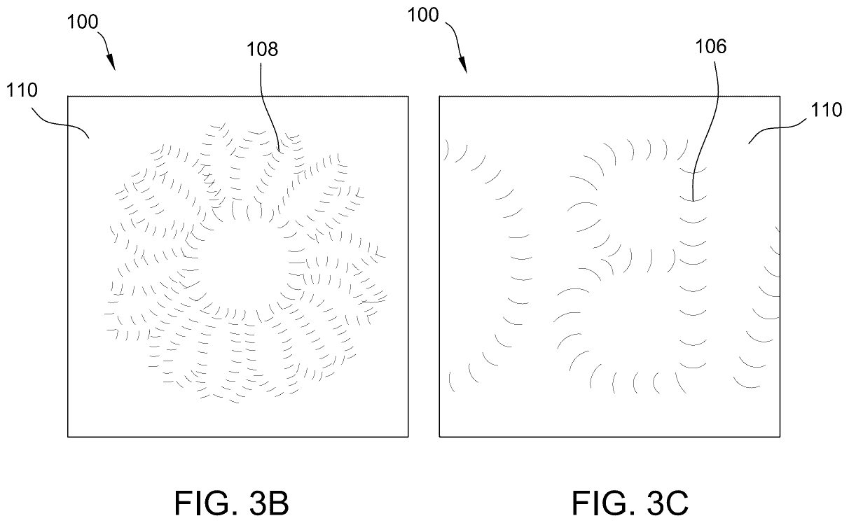

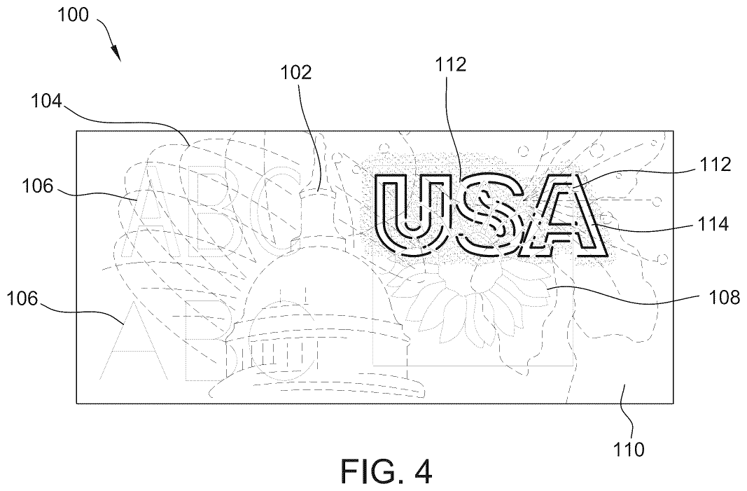

FIG. 3A illustrates the portion of security document 100 shown in FIG. 1 under a backlit security document 100 using a white light shining directly on the back of security document 100. FIGS. 3B and 3C illustrate the backside of the portion of security document 100 shown in FIG. 1 under a back white light that is shining directly on security document 100. The brightness of the light seen through features 106 and 108 is not dependent on the preprinted features or the background coloration. Rather, the deeper the trenches extend into card core 100, the brighter the light that shines through the ablated features on card core 100. FIGS. 3B and 3C illustrate laser ablated features 106 and 108 as viewed from the back. Note that the ablated features 106 and 108 are lightly visible from the backside under direct light.

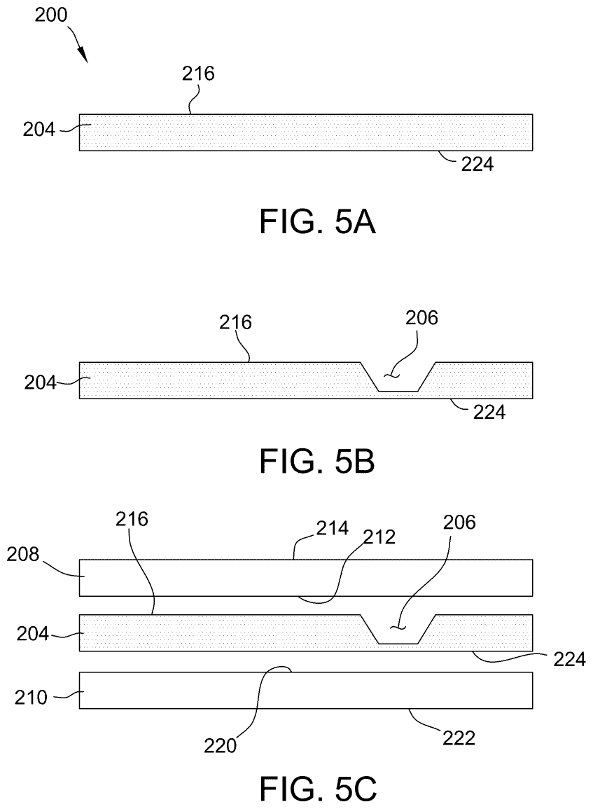

FIG. 4 illustrates security document 100 shown in FIG. 1 under an IR or UV light shining directly on the front of security document 100. As shown in FIG. 4, security document 100 includes either a preprinted or personalized invisible security feature 114 exemplified by the letters USA. As illustrated in FIGS. 1-3C, security feature 114 is not visible under ambient light or direct white light, but becomes highly visible under UV light when printed with a UV ink, or IR light when printed with an IR ink. As illustrated in FIG. 4, portions of feature 114 have been removed by the laser ablating of security feature 108.

As illustrated and described, security document 100 includes a multitude of security features that are intertwined with, and overlay other security features.

FIGS. 5A-5E illustrate a process 200 of laser ablating and subsequent lamination of a security document 202. Process 200 starts with a preprinted card core 204 as shown in FIG. 5A. Card core 204 is then CO₂ laser ablated to create a trench 206 as shown in FIG. 5B. A top laminate layer 208 and a bottom laminate layer 210 are then applied to card core 204 as shown in FIG. 5C. Top laminate layer 208 includes an inner surface 212 and an outer surface 214. Top laminate layer inner surface 212 will be adhered to a top outer surface 216 of card core 204. Bottom laminate layer 210 also includes an inner surface 220 and an outer surface 222. Bottom laminate layer inner surface 220 will be adhered to a bottom outer surface 224 of card core 204.

An air gap 226 occurs initially upon aligning top laminate layer 208 to card core 204 as shown in FIG. 5D. As top lamination layer is heated, air gap 226 is removed and replaced by laminate top layer 208 as shown in FIG. 5E. It is the removal of air gap 226 from between card core 204 and top laminate layer 208 that creates a depression 228 in top laminate layer outer surface 214. In practice, as depression 228 overlays the laser ablated second set of information described above with regard to FIG. 1, depression 228 can have different depths corresponding to different depths of the ablated trenches.

As those skilled in the art will appreciate, the CO₂ laser can be focused at a specific setting to produce lines, holes, dashes and patterns of a predetermined size, depth and spacing. This ablating process creates a pattern that can be tactile or non-tactile, and may not be readily visible when viewed straight on (e.g., the pattern is visible only in low angle reflected light).

In an alternate embodiment, a tactile and/or non-OVD pattern is created by adjusting the depth, angle, and area location of the laser engraving. In this alternative implementation, the feature cannot be photocopied.

Either fixed or variable data can be imparted onto the core's surface by laser ablating the core prior to lamination. Because the imparted laser pattern is below the lamination, and the lamination layer overlying the laser pattern is intact, there is little or no impact on existing expected wear durability during the document's useful life.

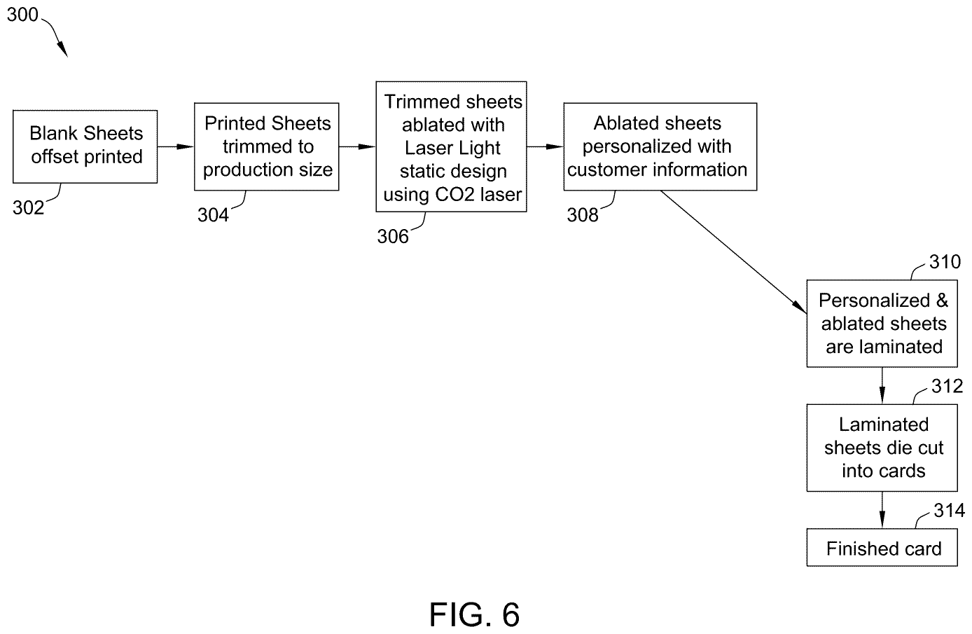

FIG. 6 illustrates the process 300 of manufacturing security document 100 shown in FIG. 1 that utilizes a static data implementation. Process 300 starts by creating a pre-print design. In one embodiment, this preprint design can accept another design or variable data (such as alphanumeric data). Process 300 includes the step of offset printing 302 the created design onto blank sheets of core card stock. The printed sheets are then trimmed 304 to production size and these trimmed sheets are laser ablated 306 to create trenches that form an ablated static design, or pattern. In one embodiment, the trenches are approximately 4-7 mils deep. A portion of the ablated design overlies and removes surface material from the core and also a portion of the pre-printed design. The ablated sheets are then personalized 308 with an individual's personal information by printing that information on the card core. The personalized and ablated sheets are laminated 310 by adhering a layer of laminate to the top and bottom of the card core and then die cut 312 to create finished cards 314. Upon completion of the lamination process, an outer surface of the top laminate layer includes depressions that overlay the ablated design. In one embodiment, the depressions are about 2-5 mils deep.

In one embodiment, the power and speed of the laser is varied to create trenches having different depths and the laminate depressions have different depths that correspond to the depths of the trenches they overlay. In this embodiment, at least some of the laminate layer outer surface depressions aligned with the ablated pattern produce a tactile characteristic on the outer surface of the laminate layer. Additionally, the ablating of the pattern that overlies the printed design produces an optically variable effect that is seen when the viewing angle is changed. In one embodiment, the pre-printed design includes at least one invisible ink feature and the ablated pattern overlies and removes a portion of the printed invisible feature. In one embodiment, UV ink is used. In an alternative embodiment, IR ink is used.

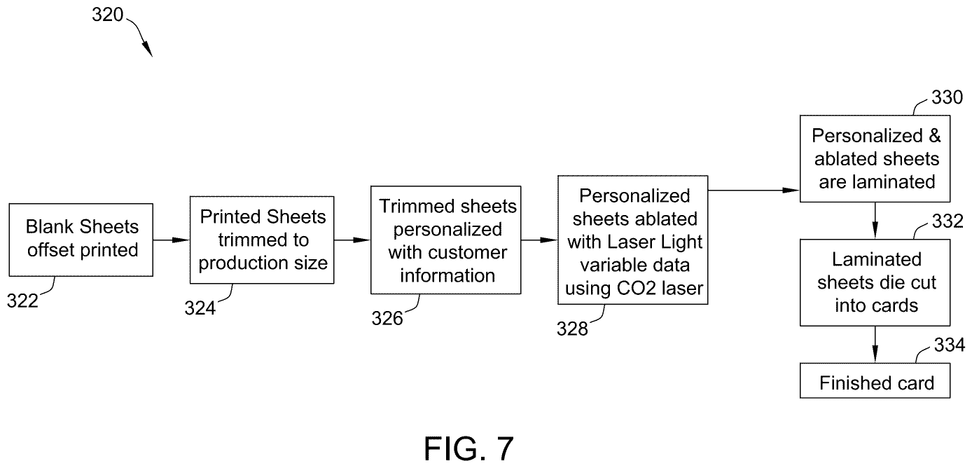

FIG. 7 illustrates an alternative process 320 of manufacturing security document 100 shown in FIG. 1 that utilizes a variable data implementation. Process 320 starts by creating a pre-print design. In one embodiment, this preprint design can accept another design or variable data (such as alphanumeric data). Process 320 includes the step of offset printing 322 the created design onto blank sheets of core card stock. The printed sheets are trimmed 324 to production size and then personalized 326 with an individual's personal information by printing that information on the card core. The sheets are then laser ablated 328 to create trenches that form ablated variable data, a design, or pattern. In one embodiment, the trenches are approximately 4-7 mils deep. A portion of the ablated design overlies and removes surface material from the core and also a portion of the pre-printed design. The personalized and ablated sheets are laminated 330 by adhering a layer of laminate to the top and bottom of the card core and then die cut 332 to create finished cards 334. Upon completion of the lamination process, an outer surface of the top laminate layer includes depressions that overlay the ablated design. In one embodiment, the depressions are about 2-5 mils deep.

In one embodiment, the power and speed of the laser is varied to create trenches having different depths and the laminate depressions have different depths that correspond to the depths of the trenches they overlay. In this embodiment, at least some of the laminate layer outer surface depressions aligned with the ablated pattern produce a tactile characteristic on the outer surface of the laminate layer. Additionally, the ablating of the pattern that overlies the printed design produces an optically variable effect that changes with the angle of view. In one embodiment, the pre-printed design includes at least one invisible ink feature and the ablated pattern overlies and removes a portion of the printed invisible feature. In one embodiment, UV ink is used. In an alternative embodiment, IR ink is used.

Illustrative examples of ID document materials which can be laser ablated in accordance with at least some embodiments include (but are not limited to) polyester, polycarbonate (PC), fused polycarbonate, polyvinyl chloride (PVC), polyethylene, thermosets, thermoplastic and thermoplastic resins (including those that foam when heated), engineering thermoplastics (ETP), polyurethane, polyamides, expanded polypropylene (EPP), polypropylene, acrylonitrile butadiene styrene (ABS), ABS/PC and ABS/PC products, high impact polystyrene (HIPS), polyethylene terephthalate (PET), PET-G, PET-F, polybutylene terephthalate (PBS), acetal copolymer (POM), and polyetherimide (PEI), polymer, copolymer, polyester, amorphous polyester, polyolefin, silicon-filled polyolefin, TESLIN, foamed polypropylene film, polystyrene, polyacrylate, poly(4-vinylpyridine, poly(vinyl acetate), polyacrylonitrile, polymeric liquid crystal resin, polysulfone, polyether nitride, and polycaprolactone, as well as virtually any known plastic or polymer. Of course, it will be appreciated that embodiments have applicability for the laser ablating, engraving and/or marking of plastic materials used to make many different articles formed by virtually any known method, including molding and extruding.

Further, while some of the examples above are disclosed with specific core components (e.g., TESLIN), we note that our compositions, methods, articles, features, and processes can be applied to other core-based identification documents as well, including those documents manufactured from other materials. For example, where an embodiment has shown polycarbonate or polyester as an example over-laminate, those skilled in the art will appreciate that many other over laminate materials can be used as well.

The particular combinations of elements and features in the above-detailed embodiments are exemplary only and are not meant to be limiting. As those skilled in the art will recognize, variations, modifications, and other implementations of what is described herein can occur to those of ordinary skill in the art without departing from the spirit and the scope of the method as claimed. The technology's scope is defined in the following claims and the equivalents thereto.

Having described and illustrated the principles of the method with reference to specific implementations, it will be recognized that the method can be implemented in many other, different, forms.

Although certain words, languages, phrases, terminology, and product brands have been used herein to describe the various features of certain embodiments, their use is not intended as limiting. Use of a given word, phrase, language, terminology, or product brand is intended to include all grammatical, literal, scientific, technical, and functional equivalents. The terminology used herein is for the purpose of description and not limitation.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A card comprising:
a core layer including a first set of information printed onto the core and a second set of information ablated into the core with a laser to form one or more trenches, wherein the ablated second set of information overlies and removes a portion of the first set of information; and
a laminate layer including an inner surface adhered to the ablated core and having an outer surface.

2. The card of claim 1 wherein the outer surface of the laminate layer includes depressions overlaying at least some of the laser ablated second set of information.

3. The card of claim 1, wherein the combination of the printed first set of information and the ablated second set of information produces an optically variable effect that changes with the angle of view.

4. The card of claim 2, wherein at least some of the laminate layer outer surface depressions aligned with the ablated second set of information produce a tactile characteristic on the outer surface of the laminate layer.

5. The card of claim 1 wherein the first set of information comprises at least some invariant data, and the second set of information comprises at least some personalized data.

6. The card of claim 1, wherein the card is an identification card.

7. The card of claim 1, wherein the outer layer depressions have different depths corresponding to different depths of the ablated trenches.

8. The card of claim 1, wherein the first set of information includes at least one printed invisible feature and the ablated second set of information overlies and removes a portion of the printed invisible feature.

9. A method of manufacturing a card, said method comprising:
printing a first set of information onto a card core;
ablating a second set of information into the core with a laser to form one or more trenches, wherein the ablated second set of information overlies and removes a portion of the first set of information; and
adhering a laminate layer to the core to cover the ablated second set of information.

10. The method of claim 9, wherein printing a first set of information includes printing a first design configured to accept another design or variable data.

11. The method of claim 9, wherein ablating a second set of information includes ablating the core material to include a pattern that removes surface material from the core and also removes a portion of the printed first design from the top of the core.

12. The method of claim 9, wherein an outer surface of the laminate includes depressions that overlay the ablated second set of information.

13. The method of claim 12, wherein the laser is a CO₂ laser, and ablating a second set of information into the core includes varying the power and/or speed of the CO₂ laser to create trenches having different depths.

14. The method of claim 13 wherein the laminate depressions have different depths that correspond to the depths of the trenches they overlay.

15. The method of claim 9, wherein ablating a second set of information that overlies the printed first set of information produces an optically variable effect that changes with the angle of view.

16. The method of claim 12, wherein at least some of the laminate layer outer surface depressions produce a tactile characteristic on the outer surface of the laminate layer.

17. The method of claim 9, wherein the first set of information includes at least one printed invisible feature and ablating a second set of information that overlies the printed first set of information removes a portion of the printed invisible feature.

18. The method of claim 9, wherein the card is an ID document.
